(19) United States
(12) Patent Application Publication
(10) Pub. No.: US 2006/0125894 A1
(43) Pub. Date: Jun. 15, 2006

(54) Ink comprising casein

(76) Inventor: Paul Wight, Manchester (GB)

Correspondence Address: MORGAN LEWIS & BOCKIUS LLP, 1111 PENNSYLVANIA AVENUE NW, WASHINGTON, DC, 20004, US

(21) Appl. No.: 10/530,894

(22) PCT Filed: Sep. 4, 2003
(86) PCT No.: PCT/GB03/03837

§ 371 Date: Oct. 12, 2005

(30) Foreign Application Priority Data
Oct. 12, 2002 (GB) 0223824.4

(51) Int. Cl. G01D 11/00; C09D 11/00

(52) U.S. Cl. 347/100; 106/31.55; 106/31.84; 106/31.58; 106/31.86

(57) ABSTRACT

A process for printing a porous substrate comprising ink jet printing a colorant and casein onto the substrate to give a print in which the colorant and casein are in contact with each other.

This invention relates to an ink jet printing process, to compositions suitable for use in such a process, to printed substrate arising from the process and to the use of casein for improving the ozone fastness of colorants.

Ink jet printing is a non-contact process for forming an image on a substrate by ejection of minute droplets of ink. Current substrates used in ink jet printing are, in the main, papers coated with at least one receptor layer to receive the ink. Such coated substrates tend to be of two fundamental types: non-porous media (also called swellable media) are those coated with swellable hydrophilic resins and porous media are those coated with a high porosity surface. Porous media are becoming increasingly popular in the ink jet industry as they offer key advantages over swellable media such as quicker dry times and hence faster print speeds, improved water resistance and excellent control of dot spread and hence resolution. A key and recently discovered disadvantage of porous media has been poor ozone fastness for resultant images compared to when swellable media are used. Hence, even in the dark, printed porous media tends to fade quicker than the swellable media equivalent.

We have found that the problem of poor ozone fastness for prints on porous media may be reduced or overcome by the process of the present invention.

According to the first aspect of the invention there is provided a process for printing a porous substrate comprising ink jet printing a colorant and casein onto the substrate to give a print in which the colorant and casein are in contact with each other.

In one embodiment the colorant and casein are ink jet printed onto the substrate separately. In such embodiment it is preferred that the colorant and casein are in printed from different ink jet cartridges or are printed from separate chambers of a one ink jet cartridge. This one cartridge prints the casein, for example as a composition comprising a liquid medium and casein but no colorant and a second ink jet cartridge, or a different chamber of the first ink jet cartridge, prints the colorant, for example as a composition comprising a liquid medium and colorant but no casein.

The order which the casein and colorant are applied can also have an impact on the ozone fastness of the resultant print. It is preferred that the casein is printed first and the colorant is printed on top of the casein.

A more preferred embodiment is where both casein and the colorant are printed onto the substrate simultaneously, for example an ink comprising the casein and colorant is printed onto the substrate. A preferred ink to achieve this comprises casein, colorant and a liquid medium.

An especially preferred embodiment is where casein is printed onto the substrate in a first step and a composition comprising casein and colorant is printed onto the substrate in a second step to substantially the same area as the casein.

In all embodiments the casein is preferably applied as a composition comprising a liquid medium.

As colourants there may be mentioned pigments, dyes and mixtures thereof. Preferred colourants are dyes. Preferred dyes include azo, diazo, xanthene, anthraquinone, triaryl methane, azine, thiazine, phthalocyanine and nigrosine types. The dye preferably has a solubility in the liquid medium of at least 10% by weight at 20° C. Preferably the amount of the colorant in the ink is 0.1 to 15%, more preferably 1 to 10% and especially 2 to 8%, based on the total weight of the ink.

The liquid medium is preferably selected from water, organic solvent and more preferably a mixture of water and organic solvent. The organic solvent may comprise a mixture of different organic solvents. When the liquid medium comprises a mixture of water and organic solvent, the organic solvent is preferably a water miscible solvent.

It is preferred that when the liquid medium comprises a mixture of water and organic solvent that the weight ratio of water to organic solvent is preferably from 99:1 to 1:99, more preferably from 99:1 to 50:50 and especially from 95:5 to 70:30.

Preferred water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; diols, preferably diols having from 2 to 12 carbon atoms, for example pentane-1,5-diol, ethylene glycol, propylene glycol, butylenes glycol, pentylene glycol, hexylene glycol and thiodiglycol and oligo- and poly-alkleneglycols, preferably diethylene glycol, triethylene glycol, polyethylene glycol and polypropylene glycol; triosl, preferably glycerol and 1,2,6-hexanetriol; mono-C₁₋₄-alkyl ethers or diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-2-methoxyethoxy)ethoxy]ethanol, 2-2[-(2-ethoxyethoxy)-ethoxy]-ethanol and ethyleneglycol monoallylether; cyclic amides, preferably 2-pyrrolidone, N-methyl-2-pyrrolidone; sulphoxides, preferably sulpholane. Preferably the liquid medium comprises water and 2 or more, especially from 2 to 8, water-soluble organic solvents.

Especially preferred water-miscible organic solvents are cyclic amides, especially 2-pyrrolidone, N-methyl-pyrrolidone; diols, especially 1,5-pentane diol, ethyleneglycol, thiodiglycol, diethyleneglycol and triethyleneglycol; and mono-C₁₋₄-alkyl and C₁₋₄-alky; ethers of diols, more preferably mono-C₁₋₄-alkyl ethers of diols having 2 to 12 carbon atoms, especially 2-methoxy-2-ethoxy-2-ethoxyehtanol.

When the liquid medium comprises only organic solvent it is preferred that it is free from water, (i.e. less than 1% water by weight).

When the liquid medium comprises only organic solvent it is preferred that the solvent has a boiling point of from 30° to 200° C., more preferably of from 40° to 150° C., and especially from 500 to 125° C. The organic solvent may be water-immiscible, water-miscible or a mixture of such solvents. Preferred water-miscible organic solvents are any of the hereinbefore-described water-miscible organic solvents and mixtures thereof.

Preferred water-immiscible solvents include, for example: aliphatic hydrocarbons; esters, preferably ethyl acetate; chlorinated hydrocarbobs, preferably CH₂Cl₂; and ether, preferably diethyl ether; and mixtures thereof.

It is especially preferred that the liquid medium comprises water or a mixture of water and one or more water-miscible organic solvent(s).

The porous substrate preferably has high levels of voids within its structure. These voids are useful for soaking up compositions containing colorant.

The porous substrate can be purely organic but more preferably comprise an inorganic filler such as clay, calcium carbonate, magnesium carbonate, silica (especially surface modified silica), zeolite, alumina or a combination of two or more thereof, and optionally a binder.

The weight ratio of the inorganic filler to binder in the porous substrate has a dramatic effect on the media porosity. Too much binder and porosity may be lost almost completely. Hence preferred weight ratios of filler to binder in the porous substrate are preferably at least 2:1 respectively, more preferably at least 3:1, especially at least 4:1 and preferably up to 10:1.

Casein is a phospho-protein extracted from mammalian milk and accounts for around 80% of the total protein content. The preferred casein is derived from cows' milk.

Various extraction methods exist but preferred caseins include acid caseins, such as hydrochloric acid, sulphuric acid and lactic acid precipitated caseins. Also useful is Rennet precipitated casein where Rennet is an enzyme. Other casein production methods such as Sheffield and Spellacy continuous methods produce casein suitable for the present invention. The casein may also be a derivative thereof, e.g. a partially hydrolysed.

The casein may be in any salt form, e.g. the sodium, potassium, lithium, calcium or ammonium salt.

Casein is naturally colloidal and micellar. Casein derivatives may range from micellar to fully soluble.

Preferred caseins are the fractions known as alpha (S1), alpha (S2), Beta and Kappa fractions.

Preferably the casein is printed onto the substrate in the form of a composition comprising casein and a liquid medium.

Preferably the casein content in the composition is 0.1 to 10%, more preferably 0.5 to 8% and especially 1 to 4% by weight based the total weight of the composition and calculating the weight of casein on a 100% solids basis.

Since milk contains around 0.65% minerals, casein often contains metal ion residues. Such residues are problematic, especially in thermal ink jet printing, and lead to kogation or long term firing problems. Divalent and trivalent ions are of particular concern.

Preferably the composition comprising casein and a liquid medium has been purified to lower the content of divalent and trivalent metal ions.

More preferable is to use a casein which is substantially free from di- and trivalent metal ion.

Preferably the composition comprising casein and a liquid medium contains less than 0.1% di- and trivalent metal ions, more preferably less than 0.05% and especially less than 0.01%, wherein all percentages are by weight relative to the total weight of the composition.

Where an ink comprising casein and colorant is used in the process the ink preferably comprises low levels of di- and trivalent metal ions. Thus, according to a second aspect of the present invention, there is provided an ink comprising:
(i) 0.1 to 10 parts casein calculated on a 100% solids basis;
(ii) 0.1 to 15 parts colorant; and
(iii) 99.8 to 74.9 parts of a liquid medium;
   wherein all parts are by weight, (i)+(ii)+(iii) add to 100 parts and the ink comprises less than 0.1% by weight of di- and tri-valent metal ions.

Since casein is highly susceptible to biological fouling and degradation, the ink and composition preferably comprise a biocide. Preferred biocides are 1,2-benzisothiazolin-3-one (available as Proxel GXL™ from Avecia), Nuosept 95™ available from Hals America and glutaraldehyde available from Union Carbide.

Especially preferred is 1,2-benzisothiazolin-3-one.

Preferred levels of biocide are from 0.0001% to 0.1% and more preferably 0.001% to 0.05% by weight relative to the total weight of the relevant composition.

Where an ink comprising casein and colorant is used in the process, a more preferred composition comprises 1,2-benzisothiazolin-3-one and low levels of di- and trivalent metal ions and. Thus according to a third aspect of the present invention there is provided an ink comprising:
(i) 0.1 to 10 parts casein calculated on a 100% solids basis;
(ii) 0.1 to 15 parts colorant;
(iii) 0.0001 parts to 0.1 parts of 1,2-benzisothiazolin-3-one;
(iv) a liquid medium;
   wherein all parts are by weight, (i)+(ii)+(iii)+(iv) add up to 100 parts and the ink comprises less than 0.1% by weight of di- and tri-valent metal ions.

The viscosity of the compositions and inks for use in the present invention are preferably less than 20 mPa.s, more preferably less than 10 mPa.s and especially less than 5 mPa.s at 25° C.

Preferably compositions and inks for use in the present invention have been filtered through a filter having a pore size of less than 10 μm, more preferably less than 5 μm and especially less than 1 μm.

Preferably the surface tension of the compositions and inks for use in the present invention are between 35 and 65 dynes per cm, more preferably between 40 and 60 dynes per cm.

Compositions and inks for use in the present invention may optionally further comprise a water-dissipatable binder. The binder may be colloidal or water-soluble.

The preferred binders in the inks, compositions and in the media include starches, preferably hydroxy alkyl starches, for example hydroxyethylstarch; celluloses, for example cellulose, methylcellulose, hydroxyethylcellulose, hydroxyproplycellulose, hydroxyethyl methyl cellulose, carboxymethylcellulose (and salts thereof) and cellulose acetate butyrate; gelatin; gums, for example guar, xanthan hum and gum Arabic; polyvinylalcohol; polyvinylphosphate, polyvinylpyrrolidone; polyethylene glycol; hydrolysed polyvinylacetate, polyethylene imine, polyacrylamides, for example polyacrylamide and poly(N,N-dimethyl acrylamide) and polyacrylamido-2-methyl propane sulphonic acid); acrylamide-acrylic acid copolymers; polyvinylpyridine; polyvinylphosphate; vinylpyrrolidone-vinyl acetate copolymers; vinyl pyrrolidone-styrene copolymers; polyvinyl;amine; poly(vinyl pyrrolidonedialkylaminoalkyl alkylacrylates), for example polyvinylpyrrolidone-diethylaminomethylmethacrylate; acid-functional acrylic polymers and copolymers, for example poly(meth)acrylic acid and copolymers of (meth)acrylic acid and other (meth)acrylate monomers; amine-functional acrylic polymers and copolymers, for example polydimethylaminoethylmethacrylate; acid or amine functional urethane polymers, for example those containing dimethylolpropanoic acid and/or pendant or terminal polyethylene glycols; ionic polymers, for example poly (N,N-dimethyl-3,5-dimethylene piperidinium chloride); polyesters, preferably those which carry water-solublising groups such as sulphonic acid groups, for example polyesters obtainable by polymerising a polyol with sodiosulphoisophthalic acid.

Preferred water-dissipatable polymeric binders are: latex polymers, for example cationic, non-ionic and anionic styrene-butadiene latexes; vinyl acetate-acrylic co-polymer latexes; acrylic copolymer latexes which carry amino groups, for example containing co-polymerised dimethylaminoethyl (meth)acrylate; and dispersions of polyester, polyurethane, (meth)acrylate or vinyl polymers and copolymers thereof. The polymer dispersions are preferably prepared by emulsion polymerisation or by dispersion into water of polymers prepared by suspension, bulk or solution polymerisation.

A combination of water-soluble polymeric binders and water-dissipatable polymeric binders can be beneficial in terms of improved mechanical strength, reduced tendency for sheets to stick together and good ink absorbency.

Overall particularly good results are found when the binder is polyvinylalcohol, methylcellulose, polyvinylpyrrolidone, or any combination thereof.

Composition(s) for the present invention may comprise general additives known in the art to improve ink-jet performance. Such additives include surfactants, antifoamers, anticogation aids, biocides, dispersants, rheology modifiers, levelling agents, pH buffers and the like.

According to a fourth aspect of the present invention there is provided an ink jet printer cartridge comprising a chamber and a composition according to the second or third aspect of the present invention. Preferred porous substrates suitable for use in the present invention include Kodak Premium Ink Jet, Kodak Instant Dry PGP, Canon PR101, Epson Premium GPP and Epson PGPP.

According to a fifth aspect of the present invention there is provided the use of casein to improve the ozone fastness of a colorant, preferably a colorant existing as a print on a porous substrate. The casein may be used in any manner which brings the casein into contact with a colorant for the purpose of enhancing ozone fastness, including but not limited to the process described in the first aspect of the present invention. The colorant may be any of those listed above, although preferably the colorant is a dye.

The invention of further illustrated by the following examples in which all parts and percentages are by weight unless specified otherwise.

### EXAMPLE 1

### Ink 1—Preparation of an Ink Jet Ink Comprising Casein and Pro-Jet™ Fast Cyan 2

Casein was dissolved in water by adjusting the pH to 10-12 using aqueous sodium hydroxide. To this solution was added Pro-Jet™ Fast Cyan 2, 2-pyrolidone, thiodiglycol and Surfynol™ 465. The ink was adjusted to pH 8-10 using NaOH to give an ink having the formulation:

| Component | % by weight |
|---|---|
| Pro-Jet ™ Fast Cyan 2 | 3 |
| Casein | 2 |
| 2-pyrolidene | 5 |
| thiodiglycol | 5 |
| Surfynol ™ 465 | 2 |
| water | to 100 |

The ink was loaded into an ink jet printer and applied to the substrates indicated in Tables 1 below.
Comparative Ink

An ink was prepared in an identical manner to Example 1 except that water was used in place of casein.

The ink was applied to the substrates indicated in Tables 1 in an identical manner to Example 1.

Tests

The following tests were performed on the prints obtained from Ink 1 and the Comparative Ink:

Ozone Fastness

To evaluate ozone-fastness the prints were exposed to 100 parts per hundred million of ozone at 40° C. and 55% relative humidity for 24 hours as sustained by a test cabinet supplied by Hampden Test Equipment Model 903.

The optical density (OD) and CIE colour co-ordinates of each initial print (a, b, L, Chroma “C” and hue “h”) were measured using a Xrite 983 ™ Spectrodensitometer with 0°/45° measuring geometry, with a spectral range of 400-700 nm at 20 nm spectral intervals, using illuminant C, with a 2° (CIE 1931) observer angle and a density operation status of T.

After the ozone-fastness test, the OD and CIE colour co-ordinates were remeasured. The degree of fade ΔE is defined as the overall change in CIE colour co-ordinates L, a, b of the print and is expressed by the equation:

$$Δ E = {( Δ {L}^{2} + Δ {a}^{2} + Δ {b}^{2} )}^{0.5}$$

$$The \% OD loss is expressed by \frac{( OD INITIAL - OD AFTER FADE )}{OD INITIAL} \times 100$$

Lower values for ΔE and % OD loss represent less fade and better ozone fastness.

Ozone Fastness Results

The results are summarised in Table 1 below.

TABLE 1

| | Casein | | |
|---|---|---|---|
| Substrate | Level | ΔE | % OD Loss |
| Canon PR101 | 2% | 11.50 | 28% |
| Canon PR101 | 0% | 52.10 | 85% |
| Kodak PGP | 2% | 6.24 | 8% |
| Kodak PGP | 0% | 34.30 | 62% |

The prints obtained using casein showed much improved ozone fastness on porous media than the comparative ink which was free from casein.

1. A process for printing a porous substrate comprising ink jet printing a dye and casein onto the substrate to give a print in which the dye and casein are in contact with each other wherein the casein is applied as a composition comprising a liquid medium, the liquid medium comprises water and a water-miscible organic solvent, the weight ratio of water to water-miscible organic solvent is from 95:5 to 70:30 and the dye has a solubility in the liquid medium of at least 10% by weight at 20° C.

2. A process according to claim 1 wherein the dye and the casein are printed onto the substrate separately.

3. A process according to claim 1 wherein the dye and casein are in printed from different ink jet cartridges or are printed from separate chambers of a one ink jet cartridge.

4. A process according to claim 1 wherein an ink comprising the casein and dye is printed onto the substrate.

5. A process according to claim 1 wherein the casein is printed onto the substrate in a first step and a composition comprising casein and dye is printed onto the substrate in a second step to substantially the same area as the casein.

6. A process according to claim 1 wherein the substrate has high levels of voids within its structure.

7. A process according to claim 1 wherein the substrate comprises filler and binder in a weight ratio of at least 2:1.

8. A process according to claim 7 wherein the filler is clay, calcium carbonate, magnesium carbonate, silica, zeolite, alumina or a combination of two or more thereof.

9. A process according to claim 1 wherein the casein is substantially free from di and trivalent metal ions.

10. An ink comprising:
(i) 0.1 to 10 parts casein calculated on a 100% solids basis;
(ii) 0.1 to 15 parts dye; and
(iii) 99.8 to 74.9 parts of a liquid medium;
wherein the liquid medium comprises water and a water-miscible organic solvent, the weight ratio of water to water-miscible organic solvent is from 95:5 to 70:30 and the dye has a solubility in the liquid medium of at least 10% by weight at 20° C., all parts are by weight, (i)+(ii)+(iii) add to 100 parts and the ink comprises less than 0.1% by weight of di- and tri-valent metal ions.

11. An ink comprising:
(i) 0.1 to 10 parts casein calculated on a 100% solids basis;
(ii) 0.1 to 15 parts dye;
(iii) 0.0001 parts to 0.1 parts of 1,2-benzisothiazolin-3-one;
(iv) a liquid medium;
wherein the liquid medium comprises water and a water-miscible organic solvent, the weight ratio of water to water-miscible organic solvent is from 95:5 to 70:30 and the dye has a solubility in the liquid medium of at least 10% by weight at 20° C., all parts are by weight, (i)+(ii)+(iii)+(iv) add up to 100 parts and the ink comprises less than 0.1% by weight of di- and tri-valent metal ions.

12. A process according to claim 1 wherein the casein and dye are applied to the substrate in the form of an ink according to claim 10 or 11.

13. An ink jet printer cartridge comprising a chamber and a composition according to claim 10 or 11.

14. A method of improving the ozone fastness of a dye which comprises contacting the dye with casein.
